(19) United States
(12) Patent Application Publication
(10) Pub. No.: US 2024/0429493 A1
(43) Pub. Date: Dec. 26, 2024

(54) POLYMER ION CONDUCTIVE MEMBRANE, POLYMER ION CONDUCTIVE MEMBRANE FOR SECONDARY BATTERIES, COMPOSITE ION PERMEABLE MEMBRANE, ELECTRODE COMPLEX, AND SECONDARY BATTERY

(71) Applicant: Toray Industries, Inc., Tokyo (JP)

(72) Inventors: Yota Okuno, Otsu-shi, Shiga (JP); Ayako Shimazu, Otsu-shi, Shiga (JP); Kei Ikoma, Otsu-shi, Shiga (JP); Hiroki Eimura, Otsu-shi, Shiga (JP)

(73) Assignee: Toray Industries, Inc., Tokyo (JP)

(21) Appl. No.: 18/703,022

(22) PCT Filed: Oct. 19, 2022
(86) PCT No.: PCT/JP2022/039009

§ 371 Date: Apr. 19, 2024

(30) Foreign Application Priority Data
Oct. 20, 2021 (JP) 2021-172034

(51) Int. Cl. H01M 12/02; C08G 69/32; C08J 5/18; H01M 12/08

(52) U.S. Cl. CPC H01M 12/02; C08G 69/32; C08J 5/18; H01M 12/08; C08J 2377/06

(57) ABSTRACT

A polymer ion conductive film has an ion migration resistance in the film at 25° C. of 100 Ω or less, and a thickness of the film after each of immersion treatments under the following conditions 1 and 2 is 2.5 times or less a thickness of the film before the immersion treatment: (condition 1) immersion at 25° C. for 24 hours in a solution obtained by mixing ethylene carbonate (EC) and diethyl carbonate (DEC) at a volume ratio of 1/1; (condition 2) immersion at 25° C. for 24 hours in a 0.1 M aqueous solution of sodium hydroxide.

### CROSS-REFERENCE TO RELATED APPLICATIONS

This application is a US national stage filing under 35 U.S.C. § 371 of International Application No. PCT/JP2022/039009, filed Oct. 19, 2022, which claims priority to Japanese Patent Application No. 2021-172034, filed Oct. 20, 2021, each of which is incorporated herein by reference in its entirety.

### TECHNICAL FIELD

This disclosure relates to a polymer ion conductive film, a polymer ion conductive film for a secondary battery, a composite ion permeable film, an electrode assembly, and a secondary battery.

### BACKGROUND

In recent years, portable electronic devices have been reduced in size and enhanced in functionality. Accordingly, a secondary battery as a power source is required to have high energy density. When a metal Li can be applied to a negative electrode of the secondary battery, a significant increase in capacity can be expected compared to a current lithium ion battery. Further, when an air electrode can be applied to a positive electrode, a weight can be reduced, and thus an energy per unit weight can be increased. A metal lithium-air battery that uses the air electrode for the positive electrode and the metal lithium for the negative electrode in combination is considered to have an energy density several times or more that of the current lithium ion battery, and is expected as a next generation power source. In addition to the metal lithium, magnesium, zinc, aluminum and the like can be used for the negative electrode, and since these materials are less expensive than lithium, studies have been conducted although the capacity and the like are inferior.

In any metal negative electrode air battery, there remain many problems for practical use. First, when the air electrode is used for the positive electrode, oxygen in the air serves as an energy source, and there is a concern about crossover that at that time, water vapor is mixed in the battery and reaches the negative electrode from the positive electrode through a separator. When moisture reaches the negative electrode, not only is the metal negative electrode deactivated, but also there is a safety problem such as that ignition may occur. The metal negative electrode also has a problem that metal dendrites are formed by repeated charging and discharging. When the dendrites grow and reach the positive electrode, there is a risk of ignition due to short circuit.

Further, in a one-component type metal lithium-air battery which is currently mainly studied, there remains a problem that a product solid is precipitated on the air positive electrode and the air positive electrode is deactivated. On the other hand, in recent years, attempts have been made to dissolve the product solid by using an aqueous electrolytic solution as an electrolytic solution on an air electrode side to suppress deactivation of the positive electrode. In such a two-component type metal lithium-air battery, it is necessary to prevent penetration of the aqueous electrolytic solution from a positive electrode side to the negative electrode. It is also necessary to prevent reduction in battery activity due to crossover of an organic electrolytic solution on a negative electrode side to the positive electrode side, and the liquid separability of the separator, that is, the property of suppressing mixing of the electrolytic solutions on both surfaces of the separator becomes a problem.

To solve such a problem, JP 2017-14493 A discloses an ion conductive film containing a heat-resistant polymer and a non-aqueous electrolytic solution, in which a content of the non-aqueous electrolytic solution is 30 mass % to 90 mass % and a piercing strength is 0.3 N/μm to 3.0 N/μm, and discloses that both high heat resistance and practical ion conductivity are implemented. JP 2016-69388 A discloses a polymer electrolyte composition containing a lithium salt and a polyurethane resin having a number average molecular weight of 1,000 to 500,000, which is obtained by reacting a polyether diol having a number average molecular weight of 500 to 100,000 with an organic diisocyanate as essential components, and discloses that high ion conductivity at normal temperature can be implemented.

However, the ion conductive film described in JP 2017-14493 A is swollen with an electrolytic solution content of 30% to 90% after being immersed in an organic electrolytic solution, and it is difficult to say that the ion conductive film has sufficient liquid separability. In addition, it is easily predicted that the polymer disclosed in JP 2016-69388 A, due to its structure, is swollen with an organic electrolytic solution and cannot maintain liquid separability, and conversely, when the polymer is not swollen, it is presumed that the ion conductivity is low.

It could therefore be helpful to provide a polymer ion conductive film and a polymer ion conductive film for a secondary battery, which implement both ion conductivity and liquid separability, as well as a composite ion permeable film, an electrode composite film, and a secondary battery, which use the polymer ion conductive film.

### SUMMARY

We thus provide 1 to 22:1
1. A polymer ion conductive film, in which an ion migration resistance in the film at 25° C. is 100Ω or less, and a thickness of the film after each of immersion treatments under conditions 1 and 2 is 2.5 times or less a thickness of the film before the immersion treatment: (condition 1) immersion at 25° C. for 24 hours in a solution obtained by mixing ethylene carbonate (EC) and diethyl carbonate (DEC) at a volume ratio of 1/1; (condition 2) immersion at 25° C. for 24 hours in a 0.1 M aqueous solution of sodium hydroxide.
2. The polymer ion conductive film according to 1, in which the number of pores having a diameter exceeding 100 nm on at least a surface on one side of the polymer ion conductive film is 5 pores/μm² or less.
3. The polymer ion conductive film according to 1 or 2, in which an air permeability is 1000 sec/100 cc or more.
4. The polymer ion conductive film according to any one of 1 to 3, in which the thickness of the film after each of the immersion treatments under the conditions 1 and 2 is 1.5 times or less the thickness of the film before the immersion treatment.
5. The polymer ion conductive film according to any one of 1 to 4, in which the thickness of the film after each of the immersion treatments under the conditions 1 and 2 is 1.0 time or more and 1.5 times or less the thickness of the film before the immersion treatment.
6. The polymer ion conductive film according to any one of 1 to 5, in which a weight reduction rate when heated from 25° C. to 200° C. is 20% or less.
7. The polymer ion conductive film according to any one of 1 to 6, in which a content of one or more metal elements selected from the group consisting of lithium, sodium, magnesium, zinc, and aluminum per 1 g of a polymer constituting the polymer ion conductive film is 50 μg or more and 300,000 μg or less.
8. The polymer ion conductive film according to any one of 1 to 7, in which a Li diffusion distance determined by measurement by a pulsed field gradient nuclear magnetic resonance (PFG-NMR) method is 0.0002 μm or more and 5.5 μm or less.
9. The polymer ion conductive film according to any one of 1 to 8, in which a content of a lithium element per 1 g of a polymer constituting the polymer ion conductive film is 50 μg or more and 300,000 μg or less.
10. The polymer ion conductive film according to any one of 1 to 9, in which a lithium transport number is 0.5 or more and 1.0 or less.
11. The polymer ion conductive film according to any one of 1 to 10, including a polymer having a total atom number density of F atom, O atom, N atom, Cl atom, and S atom of 9% or more and 100% or less.
12. The polymer ion conductive film according to any one of 1 to 11, in which a thermal shrinkage rate at 200° C. is 0% or more and 10% or less.
13. The polymer ion conductive film according to 1 or 2, including one or more selected from the group consisting of polyphenylene sulfide, polyamide, polyarylene ether, polyethersulfone, polyimide, polyamide-imide, polyarylene ether ketone, and copolymers thereof.
14. A polymer ion conductive film for a secondary battery, which is the polymer ion conductive film according to any one of 1 to 13.
15. A composite ion permeable film including the polymer ion conductive film according to any one of 1 to 13 on at least one surface of an inorganic ion conductor.
16. An electrode assembly including an electrode for a battery on at least one surface of the polymer ion conductive film according to any one of 1 to 13.
17. An electrode assembly including an electrode for a battery on at least one surface of the composite ion permeable film according to 15.
18. A secondary battery including the electrode assembly according to 16 or 17.
19. A vehicle including the secondary battery according to 18.
20. An unmanned transport machine including the secondary battery according to 18.
21. An electronic device including the secondary battery according to 18.
22. A polymer ion conductive film, in which a content of one or more metal elements selected from the group consisting of lithium, sodium, magnesium, zinc, and aluminum per 1 g of a polymer constituting the polymer ion conductive film is 50 μg or more and 300,000 μg or less, and the polymer ion conductive film includes one or more selected from the group consisting of polyphenylene sulfide, polyamide, polyarylene ether, polyethersulfone, polyimide, polyamide-imide, polyarylene ether ketone, and copolymers thereof.

We provide a polymer ion conductive film having excellent ion conductivity while suppressing crossover of an electrolytic solution to an opposite side of the film, thereby capable of being used as a separator for a secondary battery, which is safe and has a high energy density, a composite ion permeable film using the polymer for a secondary battery, and an electrode assembly having an electrode for a battery on one surface of the polymer ion conductive film or the composite ion permeable film. In addition, it is possible to provide a secondary battery which is safe and has a high energy density by using the polymer ion conductive film as a separator.

### DETAILED DESCRIPTION

Hereinafter, an example will be described in detail.

In a polymer ion conductive film according to an example, an ion migration resistance in the film at 25° C. is 100 $2 or less, and a thickness of the film after an immersion treatment under each of conditions 1 and 2 is 2.5 times or less a thickness of the film before the immersion treatment:
(condition 1) immersion in a solution obtained by mixing ethylene carbonate (EC) and diethyl carbonate (DEC) at a volume ratio of 1/1 at 25° C. for 24 hours;
(condition 2) immersion in a 0.1 M aqueous solution of sodium hydroxide at 25° C. for 24 hours.

In the example, the polymer ion conductive film is a film that can be used as a separator which is a component of a secondary battery.

The polymer ion conductive film is suitably used as a polymer ion conductive film for a secondary battery. The secondary battery is a generic term for a chemical battery capable of repeating charging and discharging twice or more. The secondary battery is constructed by using, as minimum components, a positive electrode, a negative electrode, and a separator that electrically separates the positive electrode and the negative electrode from each other to not cause a short circuit. The positive electrode and the negative electrode may be made of any material. Specific positive electrode material is not particularly limited, and examples thereof include inorganic substances such as metal oxides and metal sulfides such as nickel, lithium, cobalt, and manganese; carbon materials such as graphite, carbon, and CNT; materials in which a metal is supported on the carbon materials; and air electrodes using oxygen in the air as a positive electrode active material. These positive electrode materials may be used in combination with a current collector. A negative electrode material is not particularly limited, and examples thereof include simple substances of a metal such as lithium, sodium, aluminum, magnesium, and zinc, and carbon materials and inorganic substances supporting these metals. These negative electrode materials can also be used in combination with a current collector. Any combination of the positive electrode and the negative electrode can be used as necessary.

The secondary battery may include an electrolyte or a solid electrolyte in addition to the positive electrode, the negative electrode, and the separator. The electrolyte is a generic term for substances that are dissolved in a solvent to conduct specific ions. As the solvent, any solvent such as an organic solvent or an aqueous solvent can be selected as necessary. The solid electrolyte is an electrolyte capable of conducting ions without containing a solvent. Examples of such a solid electrolyte include a gel electrolyte and an inorganic solid electrolyte.

Further, the secondary battery may include any additive for the purpose of stable operation of the battery, in addition to the positive electrode, the negative electrode, the separator, and the electrolyte.

Specific examples of such a secondary battery include a lead storage battery, a nickel-hydrogen battery, a nickel-cadmium battery, a lithium ion battery, a sodium ion battery, a nickel-iron battery, a nickel-zinc battery, a lithium metal battery, a lithium metal-air battery, an aluminum metal-air battery, a sodium-sulfur battery, a zinc-air battery, a sodium metal-air battery, and a lithium-sulfur battery. Among these batteries, from the viewpoint of excellent weight energy density, a battery using a simple substance of a metal such as lithium, sodium, aluminum, or zinc for the negative electrode is preferable, and a battery using a lithium metal is most preferable. Further, from the viewpoint of increasing the weight energy density, a metal lithium-air battery, a metal sodium-air battery, and a zinc-air battery using an air electrode as the positive electrode are more preferable.

Examples of the electrolyte preferably used in the metal lithium-air battery include lithium salts such as LiPF₆, LiAsF₆, LiClO₄, LiBF₄, LiBr, lithium bis(oxalate) borate, lithium difluoro (oxalate) borate, lithium bis(fluorosulfonyl) imide (LiFSI), lithium bis(trifluoromethylsulfonyl) imide (LiTFSI), and lithium bis(pentafluoroethanesulfonyl) imide. These lithium salts may be used alone or in combination of two or more.

Specific examples of the solvent that dissolves the electrolytes include carbonate-based solvents such as dimethyl carbonate (DMC), diethyl carbonate (DEC), ethyl methyl carbonate (EMC), ethylene carbonate (EC), and propylene carbonate (PC); sulfur-containing solvents such as dimethyl sulfoxide (DMSO) and sulfolane; lactones such as γ-butyl lactone; ether-based solvents such as tetrahydrofuran (THF), dioxane, and 1,3-dioxolane (DOL); and aqueous solvents such as water and methanol. These solvents may be used alone, and two or more thereof may be appropriately mixed and used for the purpose of adjusting potential stability and a viscosity. Different electrolytic solutions or mixtures thereof may be used on the positive electrode side and the negative electrode side via the separator.

As the polymer constituting the polymer ion conductive film, when an electrolytic solution is used in the secondary battery, a known polymer can be used as necessary as long as the polymer is not dissolved in the electrolytic solution. Specific examples thereof include polyethers such as polycarbonate, polyacetal, polyester, polysulfone, polyarylate, polyurethane, polyimide, polyamide (including polyamic acid), polyarylene sulfide, polyphenylene sulfide, polyamide-imide, polyether ether ketone, polyether imide, polyethersulfone, polyarylene ether, and polyarylene ether ketone; vinyl-based polymers such as polyethylene, polypropylene, and polymethyl methacrylate; and alloys and copolymers thereof. Among them, the polymer ion conductive film preferably contains one or more selected from the group consisting of polyphenylene sulfide, polyamide, polyarylene ether, polyethersulfone, polyimide, polyamide-imide, polyarylene ether ketone, and copolymers thereof from the viewpoint of excellent heat resistance. Polyamide, polyphenylene sulfide, polyamide-imide, and polyethersulfone are more preferable from the viewpoint of excellent moldability, polyamide, polyimide, and polyamide-imide are further preferable from the viewpoint of excellent solvent resistance, among them, aromatic polyamide, aromatic polyimide, and aromatic polyamide-imide are particularly preferable from the viewpoint of excellent heat resistance, and among them, aromatic polyamide (aramid) is most preferable from the viewpoint of high strength. These polymers may be used alone or in combination. For example, different types of polymers may be copolymerized, or may form an alloy in the film.

Polyamide, polyimide, or polyamide-imide that can be suitably used preferably contains a polymer having any of chemical formulae (1) to (3). Examples of the aromatic polyamide include those having a repeating unit represented by chemical formula (1), examples of the aromatic polyimide include those having a repeating unit represented by chemical formula (2), and examples of the aromatic polyamide-imide include those having a repeating unit represented by chemical formula (3).

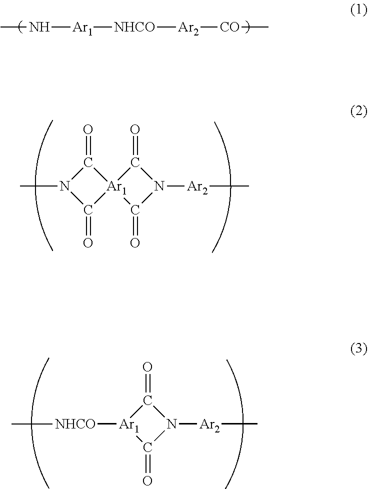

Ar₁ and Ar₂ in the chemical formulae (1) to (3) are structures containing an aromatic ring in a part of a main chain. Ar₁ and Ar₂ may have the same structure or different structures. In Ar₁ and Ar₂, for example, a plurality of aromatic rings may be bonded by an ether bond or the like, or an aliphatic group bonded to an aromatic ring may be contained in the main chain. The aromatic ring is a generic term including aromatic hydrocarbons which are cyclic unsaturated organic compounds such as benzene, and heteroaromatic compounds containing elements other than carbon in a ring structure.

A bonding hand constituting the main chain on the aromatic ring contained in Ar₁ and Ar₂ may be any of meta orientation, para orientation, and ortho orientation. Further, a part of hydrogen atoms on the aromatic ring contained in Ar₁ and Ar₂ may be substituted with any functional group. Examples of such a functional group include a hydroxy group, an ether group, a thioether group, a carboxy group, a phosphine group, and a sulfone group.

The polymer ion conductive film is characterized in that the ion migration resistance in the film at 25° C. is 100Ω or less. When an ion conduction resistance in the film is 100Ω or less, a polymer ion conductive film having excellent ion conductivity is obtained. The ion conduction resistance in the film is more preferably 80Ω or less, and further preferably 50Ω or less. The ion migration resistance in the film can be measured by an AC impedance method in a state where both surfaces of the film are sandwiched by a simple substance of the same metal as the metal ion to be measured. The ion migration resistance in the film is preferably as small as possible, and a lower limit value thereof is actually 3Ω. A method of setting the ion migration resistance in the film at 25° C. to 100Ω or less is not particularly limited and, for example, a method in which a predetermined amount of lithium element is contained in the polymer ion conductive film as described below or a method in which a battery using a film as a separator is prepared and doping is performed by repeating charging and discharging is preferable.

The polymer ion conductive film is characterized in that a film thickness after the immersion treatment under condition 1 is 2.5 times or less a film thickness before the immersion treatment. Similarly, the polymer ion conductive film is characterized in that the film thickness after the immersion treatment under condition 2 is 2.5 times or less the film thickness before the immersion treatment. In each immersion treatment, the entire film is immersed in the solution. (condition 1) immersion in a solution obtained by mixing ethylene carbonate (EC) and diethyl carbonate (DEC) at a volume ratio of 1/1 at 25° C. for 24 hours; (condition 2) immersion in a 0.1 M aqueous solution of sodium hydroxide at 25° C. for 24 hours.

It is indicated that in each of the immersion treatments, as the increase in the film thickness after the immersion treatment is smaller, the polymer ion conductive film is less likely to swell with the electrolytic solution. Accordingly, the ratio at which the electrolytic solutions on both sides of the film are mixed via the polymer ion conductive film is reduced, and the liquid separability is improved, which contributes to stable driving of the battery. The film thickness after each of the the immersion treatments under the conditions 1 and 2 is preferably 2.0 times or less, more preferably 1.8 times or less, and further preferably 1.5 times or less the film thickness before the immersion treatment. When the film thickness after the immersion treatment is less than 1.0 times indicates that the polymer ion conductive film is dissolved in a solution obtained by mixing ethylene carbonate (EC) and diethyl carbonate (DEC) at a volume ratio of 1/1 or in 0.1 M sodium hydroxide, and thus is not suitable. Therefore, a preferable lower limit of the change in the film thickness is 1.0 time. Therefore, the thickness of the film after the immersion treatment under each of the conditions 1 and 2 is more preferably 1.0 time or more and 1.5 times or less the thickness of the film before the immersion treatment. In examples of a specific method of performing the immersion treatment under each of the conditions 1 and 2, two samples are prepared from the same polymer ion conductive film, and one sample is subjected to the immersion treatment under the condition 1 and the other sample is subjected to the immersion treatment under the condition 2. A method of relatively reducing the increase in the film thickness after the immersion treatment is not particularly limited, and examples thereof include the use of the polymer of the above-described preferable type for the polymer ion conductive film.

An air permeability of the polymer ion conductive film is preferably 1,000 sec/100 cc or more. The air permeability is more preferably 5,000 sec/100 cc or more, and further preferably 10,000 sec/100 cc or more. When the air permeability is less than 1,000 sec/100 cc, the polymer ion conductive film often has a physical through hole, an effect of blocking penetration of dendrites or the like may not be obtained, and in addition, it tends to be difficult to suppress liquid permeation. When the air permeability is 1,000 sec/100 cc or more, penetration of dendrites or the like is easily blocked, and liquid permeation is easily suppressed, which is preferable. To set the air permeability within such a range, the polymer film is preferably formed by a production method to be described later.

An ion conductivity of the polymer ion conductive film is preferably 1.0×10⁻⁵ S/cm or more. The term “ion conductivity” refers to a value measured by a measurement method to be described later in an environment at 25° C. The ion conductivity is preferably 5.0×10⁻⁵ S/cm or more, more preferably 1.0×10⁻⁴ S/cm or more, and further preferably 5.0×10⁻⁴ S/cm or more. By setting the ion conductivity within the above range, the ion permeability inside the battery is high, and excellent output characteristics and cycle characteristics are obtained. When the ion conductivity is less than 1.0×10⁻⁵ S/cm, the ion permeability is low, the output characteristics deteriorate, and the capacity deterioration may increase when repeatedly used. The ion conductivity is preferably as large as possible, an upper limit thereof is not particularly limited and, for example, the ion conductivity may be 5.0×10⁻² S/cm or less. To set the ion conductivity within such a range, it is preferable to form a polymer film using a polymer to be described later.

In the polymer ion conductive film, the number of pores having a diameter exceeding 100 nm is preferably 5 pores/μm² or less on at least a surface on one side. The number of pores having a diameter exceeding 100 nm is a value determined by the following method. That is, the number of recesses having a diameter exceeding 100 nm is counted in a state where an arbitrary position on a film surface is enlarged to 20,000 times by a scanning electron microscope (SEM). This is performed at five different locations, and a number average thereof is calculated and converted into the number per 1 μm² to obtain the number of pores (pore/μm²). A diameter of the pore can be determined by any method such as ruler or image analysis software as necessary. As the number of pores having a diameter exceeding 100 nm is smaller, the ratio at which the electrolytic solutions on both sides of the film are mixed via the polymer ion conductive film is reduced, and the liquid separability is improved, which contributes to stable driving of the battery. When the number of pores having a diameter exceeding 100 nm is relatively small, the dendrite resistance of the polymer ion conductive film can be improved. When the polymer ion conductive film has excellent dendrite resistance, the safety of the secondary battery using the polymer ion conductive film can be further improved. The number of such pores is more preferably 4 pores/μm² or less, and further preferably 3 pores/μm² or less. According to the definition, a lower limit thereof is 0 pores/μm². When a shape of the pore is not circular, a distance of a straight line drawn from an end to another end of the pore so as to be longest is defined as the diameter. A method of relatively reducing the number of pores is not particularly limited, and examples thereof include a method in which drying conditions at the time of film formation are set to a preferable method as described later.

Further, in the polymer ion conductive film, a weight reduction rate when heated from 25° C. to 200° C. is preferably 20% or less. It is indicated that as such a weight reduction rate is lower, the polymer ion conductive film is stable and hardly decomposed even at a high temperature, which contributes to the safety of the battery when the polymer ion conductive film is used as a separator. The weight reduction rate is more preferably 15% or less, further preferably 10% or less, and still more preferably 5% or less. According to the definition, a lower limit thereof is 0%. The weight reduction rate is determined by the weight when the polymer ion conductive film is introduced into a thermogravimetric analyzer (TGA), heated from room temperature (25° C.) to 200° C. at 10 K/min, and held at 200° C. for 1 hour. A method of relatively reducing the weight reduction rate is not particularly limited, and examples thereof include handling under drying conditions to prevent moisture absorption after film formation.

In the polymer ion conductive film, a thermal shrinkage rate at 200° C. is preferably 0% or more and 10% or less. The thermal shrinkage rate at 200° C. is more preferably 8% or less, and further preferably 5% or less. When the thermal shrinkage rate is the above upper limit value or less, runaway of an exothermic reaction inside the battery can be suppressed, and the battery can exhibit high safety. The thermal shrinkage rate at 200° C. is preferably as small as possible, and is usually 0% or more. The thermal shrinkage rate at 200° C. can be measured by a method described in the Examples.

In the polymer ion conductive film, a content of one or more metal elements selected from the group consisting of lithium, sodium, magnesium, zinc, and aluminum is preferably 50 μg or more per 1 g of the polymer constituting the polymer ion conductive film from the viewpoint of improving the ion conductivity. When the polymer ion conductive film contains one or more metal elements selected from the group consisting of lithium, sodium, magnesium, zinc, and aluminum, the ion mobility is increased and practical battery performance can be obtained. The content of one or more metal elements selected from the group consisting of lithium, sodium, magnesium, zinc, and aluminum per 1 g of the polymer constituting the polymer ion conductive film is more preferably 100 μg or more, further preferably 200 μg or more, particularly preferably 500 μg or more, significantly preferably 1,000 μg or more, and most preferably 2,000 μg or more. When the content of one or more metal elements selected from lithium, sodium, magnesium, zinc, and aluminum is less than 50 μg, sufficient ion conductivity may not be obtained when used in a secondary battery, and battery characteristics may be deteriorated. An upper limit of such a content is not particularly limited, and is preferably 300,000 μg or less because when the content is too large, the handleability is decreased due to moisture absorption. That is, the content of one or more metal elements selected from the group consisting of lithium, sodium, magnesium, zinc, and aluminum per 1 g of the polymer constituting the polymer ion conductive film is preferably 50 μg or more and 300,000 μg or less. The above means that the polymer ion conductive film may contain one or more metal elements selected from the group consisting of lithium, sodium, magnesium, zinc, and aluminum, and the content of at least one of the metal elements may be within the above range. Alternatively, the metal elements of which the content is within the above range, among one or more metal elements selected from the group consisting of lithium, sodium, magnesium, zinc, and aluminum, may be two or more. The content of one or more metal elements selected from the group consisting of lithium, sodium, magnesium, zinc, and aluminum can be evaluated by using a known method such as atomic absorption spectrometry or ICP emission spectrometry.

The polymer ion conductive film preferably contains 50 μg or more of the lithium element per 1 g of the polymer constituting the polymer ion conductive film from the viewpoint of improving the ion conductivity. By containing the lithium element having a relatively small atomic weight in the polymer ion conductive film, the ion mobility is increased and practical battery performance can be obtained particularly when lithium ions are used as a migratory medium. The content of the lithium element per 1 g of the polymer constituting the polymer ion conductive film is more preferably 100 μg or more, further preferably 200 μg or more, particularly preferably 500 μg or more, significantly preferably 1,000 μg or more, and most preferably 2,000 μg or more. When the content of the lithium element is less than 50 μg, sufficient ion conductivity may not be obtained when used in a secondary battery, and battery characteristics may be deteriorated. An upper limit of such a content is not particularly limited, and is preferably 300,000 μg or less because when the content is too large, the handleability is decreased due to moisture absorption. That is, the content of the lithium element per 1 g of the polymer constituting the polymer ion conductive film is preferably 50 μg or more and 300,000 μg or less. The content of the lithium element can be evaluated by a known method such as atomic absorption spectroscopy or ICP emission spectrometry.

The lithium element contained in the polymer ion conductive film may be added in the polymer film in a state of a lithium salt as an electrolyte. From the viewpoint of thermal and electrochemical stability, the lithium salt is preferably LiPF₆, LiAsF₆, LiClO₄, LiBF₄, LiBr, lithium bis(oxalate) borate, lithium difluoro (oxalate) borate, lithium bis(fluorosulfonyl) imide, lithium bis(trifluoromethylsulfonyl) imide, lithium bis(pentafluoroethanesulfonyl) imide or the like. These lithium salts may be used alone or in combination of two or more kinds. Similarly, one or more metal elements selected from the group consisting of sodium, magnesium, zinc, and aluminum contained in the polymer ion conductive film may be added in the polymer film in a state of a salt as the electrolyte.

In the polymer ion conductive film, a Li diffusion distance measured by a pulsed field gradient nuclear magnetic resonance (PFG-NMR) method (“PFG-NMR”) is preferably 0.0002 μm or more and 5.5 μm or less, more preferably 0.5 μm or more and 5.5 μm or less, further preferably 3.5 μm or more and 5.5 μm or less, and particularly preferably 3.5 μm or more and 4.5 μm or less. When the Li diffusion distance determined by measurement by PFG-NMR is within the above range, both ion conductivity and liquid separability can be implemented. When the Li diffusion distance is extremely small, the ion conductivity may not be exhibited. When the Li diffusion distance is extremely large, solvent molecules are easily diffused simultaneously with Li, and the liquid separability decreases. The Li diffusion distance determined by measurement by PFG-NMR can be evaluated using a known method using PFG-NMR.

In the polymer ion conductive film, a lithium transport number is preferably 0.5 or more and 1.0 or less, more preferably 0.6 or more and 1.0 or less, further preferably 0.7 or more and 1.0 or less, and still more preferably 0.8 or more and 1.0 or less. When the lithium transport number is within the above range, side reactions in the battery and a decrease in liquid separability can be suppressed, and good battery characteristics can be exhibited. The lithium transport number can be evaluated by a known method using an AC impedance method and a DC method.

The polymer ion conductive film preferably contains a polymer in which a total atom number density of F atom, O atom, N atom, Cl atom, and S atom is 9% or more and 30% or less, more preferably 11% or more and 20% or less, and particularly preferably 14% or more and 16% or less. When the total atom number density of the F atom, the O atom, the N atom, the Cl atom, and the S atom of the polymer is within the above range, the conductivity of the metal ion can be exhibited while implementing liquid separability. The metal ion is conducted by interaction with the F atom, the O atom, the N atom, the Cl atom, or the S atom. The total atom number density of the polymer means a ratio of the total atom number of the F atom, the O atom, the N atom, the Cl atom, and the S atom in the polymer to the number of atoms constituting the polymer, and is uniquely determined from a chemical structure thereof when the composed polymer is known. When the chemical structure of the polymer is unclear, the chemical structure of the polymer can be identified by mass spectrometry, NMR, IR, or a known method using an elemental analyzer. In the above, the polymer does not need to contain all of the F atom, the O atom, the N atom, the Cl atom, and the S atom, and may contain one or more atoms selected from the group consisting of the F atom, the O atom, the N atom, the Cl atom, and the S atom, and the total atom number density of the contained atoms may be within the above range.

A thickness of the polymer ion conductive film is preferably 0.05 μm or more and 30 μm or less. When the thickness of the polymer ion conductive film is 0.05 μm or more, the strength of the polymer ion conductive film can be improved, and it is easy to ensure the safety when the polymer ion conductive film is used in a secondary battery. The thickness of the polymer ion conductive film is more preferably 0.50 μm or more, and further preferably 1.0 μm or more. On the other hand, when the thickness of the polymer ion conductive film is 30 μm or less, it is possible to suppress an increase in resistance in a thickness direction of the film and to suppress deterioration in characteristics of the secondary battery. The thickness of the polymer ion conductive film is preferably 30 μm or less, more preferably 20 μm or less, further preferably 15 μm or less, and particularly preferably 10 μm or less.

The polymer ion conductive film may be used in a form of being laminated on another porous polymer film or different ion conductive film. In particular, when the polymer ion conductive film is formed on a surface of the porous polymer film, high ion conductivity, dendrite resistance, and liquid separability can be simultaneously implemented, which is preferable. As a porous polymer, a known porous polymer can be used and, for example, a polyethylene porous film or a polypropylene porous film is commercially available and thus can be used.

Examples of preferred aspects of the polymer ion conductive film include the following. That is, in the polymer ion conductive film, it is preferable that the content of one or more metal elements selected from the group consisting of lithium, sodium, magnesium, zinc, and aluminum per 1 g of the polymer constituting the polymer ion conductive film is 50 μg or more and 300,000 μg or less, and that the polymer ion conductive film contains one or more selected from the group consisting of polyphenylene sulfide, polyamide, polyarylene ether, polyethersulfone, polyimide, polyamide-imide, polyarylene ether ketone, and copolymers thereof.

This disclosure also relates to a composite ion permeable film having a polymer ion conductive film on at least one surface of an inorganic ion conductor. In the composite ion permeable film, preferred aspects of the polymer ion conductive film are the same as those described above. The inorganic ion conductor has high ion conductivity, but is inferior to the polymer ion conductive film described above in terms of dendrite resistance and liquid separability. On the other hand, a composite ion permeable film obtained by the combination of the polymer ion conductive film and the inorganic ion conductor can implement high ion conductivity, dendrite resistance, and liquid separability, which contributes to a secondary battery having both safety and high performance. As the inorganic ion conductor, a known inorganic ion conductor can be appropriately used, and examples of an inorganic solid electrolyte include sulfide-based solid electrolytes such as Li₂S—P₂S₅ and Li₇P₃S₁₁, and oxide-based solid electrolytes such as LiI and Li₂O—B₂O₃—P₂O₅. A shape of the inorganic ion conductor is not particularly limited, and when being used for the composite ion permeable film, generally, an inorganic ion conductor in the form of being coated or formed in a sheet shape is preferably used.

This disclosure also relates to an electrode assembly having an electrode for a battery on at least one surface of a polymer ion conductive film or a composite ion permeable film. In the electrode assembly, preferred aspects of the polymer ion conductive film and the composite ion permeable film are the same as those described above. In particular, according to the electrode assembly including the polymer ion conductive film or the composite ion permeable film described above on the surface of the metal negative electrode, the growth of dendrites on the electrode surface can be suppressed.

The polymer ion conductive film is suitably used for a secondary battery. That is, this disclosure relates to a polymer ion conductive film for a secondary battery, which is the above-described polymer ion conductive film. The polymer ion conductive film for a secondary battery is a film that can be used as a separator which is a component of the secondary battery. Preferred aspects of the polymer ion conductive film in the polymer ion conductive film for a secondary battery are the same as that of the polymer ion conductive film, and the polymer ion conductive film for a secondary battery may be used in the composite ion permeable film or the electrode assembly described above.

This disclosure also relates to a secondary battery including the polymer ion conductive film (polymer ion conductive film for a secondary battery) described above as a separator. That is, this disclosure also relates to a secondary battery including the polymer ion conductive film, the composite ion permeable film, or the electrode assembly described above. In the secondary battery, preferred aspects of the polymer ion conductive film, the composite ion permeable film, and the electrode assembly are the same as those described above. Since the polymer ion conductive film described above has both low ion migration resistance and excellent liquid separability, a secondary battery using the polymer ion conductive film can implement both high performance and safety. A type of the secondary battery is not particularly limited, and a battery using a metal lithium negative electrode is particularly preferable because both high energy density and safety can be implemented. In addition, the polymer ion conductive film is suitable for use in a battery in which the electrolytic solutions used on a positive electrode side and a negative electrode side are different, and a battery in which a dissolved product or a side reaction product generated in one electrode has a bad influence on the other electrode. Specifically, the polymer ion conductive film is preferably used for a two-component battery, a lithium-sulfur battery, a clay battery or the like. Further, a metal lithium-air battery is more preferable because a high energy density is obtained, and among them, a two-component metal lithium-air battery in which the kind of the electrolytic solution is different between the positive electrode side and the negative electrode side is most preferable.

The secondary battery can be suitably used as a power source of a small-sized electronic device such as a mobile terminal, a vehicle such as an electric vehicle (EV), a hybrid electric vehicle (HEV), a plug-in hybrid electric vehicle (PHEV), or a UAM, a large-sized industrial device such as an industrial crane, or an unmanned transport machine such as a drone or a high altitude platform station (HAPS). It can also be suitably used as a power storage device for leveling of electric power in a solar cell, a wind turbine generator or the like or for a smart grid. The secondary battery is particularly preferably used in a vehicle, an electronic device, and an unmanned transport machine, which are required to have lightweight properties. That is, this disclosure relates to an article including the secondary battery. The article is preferably one or more selected from the group consisting of an electronic device, a vehicle, an industrial device, an unmanned transport machine, and a power storage device, and particularly preferably one or more selected from the group consisting of a vehicle, an electronic device, and an unmanned transport machine.

Next, a production method of a polymer ion conductive film according to the example will be described.

In the example, a method of obtaining a polymer that can be used as an ion conductive polymer will be described by taking an aromatic polyamide, an aromatic polyimide, or a polyamic acid as a precursor thereof as an example. However, the polymer that can be used and a polymerization method thereof are not limited thereto.

As a method of obtaining the aromatic polyamide, various methods may be used and, for example, when a low-temperature solution polymerization method is used using acid dichloride and diamine as raw materials, the aromatic polyamide is synthesized in an aprotic polar organic solvent such as N-methylpyrrolidone, N,N-dimethylacetamide, dimethylformamide, and dimethylsulfoxide. In solution polymerization, to obtain a polymer having a high molecular weight, a moisture content of the solvent used for polymerization is preferably 500 ppm or less (on a mass basis, the same applies hereinafter), and more preferably 200 ppm or less. Further, a metal salt may be added for the purpose of promoting dissolution of the polymer. The metal salt is preferably a halide of an alkali metal or an alkaline earth metal dissolved in the aprotic organic polar solvent, and examples thereof include lithium chloride, lithium bromide, sodium chloride, sodium bromide, potassium chloride, and potassium bromide. When both the acid dichloride and the diamine to be used are used in an equal amount, a polymer having an ultra-high molecular weight may be generated and, therefore, it is preferable to adjust a molar ratio so that one of the acid dichloride and the diamine becomes 95.0 mol % to 100.0 mol % of the other. A polymerization reaction of the aromatic polyamide involves heat generation, and when a temperature of a polymerization system increases, a side reaction may occur and the degree of polymerization may not be sufficiently increased and, therefore, a temperature of the solution during polymerization is preferably cooled to 40° C. or lower. Further, when acid dichloride and diamine are used as raw materials, hydrogen chloride is produced as a by-product in the polymerization reaction, and to neutralize the hydrogen chloride, an inorganic neutralizing agent such as lithium carbonate, calcium carbonate, and calcium hydroxide, or an organic neutralizing agent such as ethylene oxide, propylene oxide, ammonia, triethylamine, triethanolamine, and diethanolamine may be used.

On the other hand, when the aromatic polyimide or the polyamic acid as a precursor thereof which can be used in the example is polymerized using, for example, a tetracarboxylic anhydride and an aromatic diamine as raw materials, a method of synthesizing by solution polymerization in an aprotic organic polar solvent such as N-methyl-2-pyrrolidone, N,N-dimethylacetamide, dimethylformamide, and dimethylsulfoxide can be adopted. When both the tetracarboxylic anhydride and the aromatic diamine as raw materials are used in an equal amount, a polymer having an ultra-high molecular weight may be generated and, therefore, it is preferable to adjust a molar ratio so that one of the tetracarboxylic anhydride and the aromatic diamine becomes 90.0 mol % to 99.5 mol % of the other. The polymerization reaction involves heat generation, and when the temperature of the polymerization system increases, precipitation may occur by an imidization reaction and, therefore, the temperature of the solution during polymerization is preferably 70° C. or lower. As a method of imidizing aromatic polyamic acid synthesized in this manner to obtain an aromatic polyimide, a heat treatment, a chemical treatment, and a combination thereof are used. The heat treatment method is generally a method of imidizing polyamic acid by a heat treatment at about 100° C. to 500° C. On the other hand, examples of the chemical treatment include a method of using a tertiary amine such as triethylamine as a catalyst and a dehydration agent such as an aliphatic acid anhydride or an aromatic acid anhydride, and a method of using an imidization agent such as pyridine.

A viscosity η of aromatic polyamide, aromatic polyimide, or polyamic acid as a precursor thereof is preferably 0.5 dL/g to 7.0 dL/g. When the viscosity is within the above range, a polymer having excellent toughness and strength and excellent ion conductivity can be obtained.

Next, a method of forming a polymer ion conductive film according to the example will be described.

A polymer solution after polymerization may be used as it is as a film-forming raw solution, and when the solution contains a large amount of an unnecessary substance such as a neutralized salt, it is preferable to isolate the polymer once and redissolve the polymer in the above-described aprotic organic polar solvent or an organic solvent such as sulfuric acid. A method of isolating the polymer is not particularly limited, and examples thereof include a method in which the polymer solution after polymerization is added to a large amount of water little by little to extract the solvent and the neutralized salt in water, and only the precipitated polymer is separated and then dried. A polymer solid from which unnecessary substances such as neutralized salt are removed can be dissolved again in a good solvent to be used as a film-forming raw material. A dissolution concentration at this time is preferably 5 wt % or more and 30 wt % or less from the viewpoint of film forming properties.

A lithium element is preferably added to the polymer solution before film formation. By this operation, the lithium element is contained in a concentration of 50 μg or more in 1 g of the obtained polymer, and the ion conductivity of the obtained polymer ion conductive film is improved. A method of adding such a lithium element is not particularly limited, and examples thereof include a method of adding lithium metal or a lithium salt to the polymer solution. The lithium salt is not particularly limited, and examples thereof include LiPF₆, LiAsF₆, LiClO₄, LiBF₄, LiBr, lithium bis(oxalate) borate, lithium difluoro (oxalate) borate, lithium bis(fluorosulfonyl) imide, lithium bis(trifluoromethylsulfonyl)imide, and lithium bis(pentafluoroethanesulfonyl) imide. An addition amount of the lithium element is preferably 50 μg or more with respect to 1 g of the polymer weight, and the content of the lithium element in the polymer ion conductive film to be obtained is more preferably in the above-described preferred range. When a polymer ion conductive film containing a predetermined amount of one or more metal elements selected from the group consisting of sodium, magnesium, zinc, and aluminum is obtained, one or more metal elements selected from the group consisting of sodium, magnesium, zinc, and aluminum may be added to the polymer solution, for example, in the form of a simple substance of a metal or a metal salt, as in the lithium element.

The polymer solution prepared as described above, preferably the polymer solution subjected to removal of unnecessary substances and addition of lithium element or the like, can be formed into a film by a so-called solution film-forming method. Examples of the solution film-forming method include a dry-wet method, a dry method, and a wet method, and it is preferable to use a dry method from the viewpoint of suppressing elution of the lithium element and the like of an electrolyte layer. In a drying step for removing the solvent, drying conditions may be a drying temperature and a drying time at which a polymer and an additive such as a lithium salt is not decomposed and, for example, 50° C. to 220° C. and 120 minutes or shorter is preferable. However, when it is desired to obtain a film made of polyamic acid by using a polyamic acid polymer without imidization, the drying temperature is preferably 50° C. to 150° C. In any polymer, the drying condition is more preferably 50° C. to 130° C. under a reduced pressure.

Through these steps, the above-described polymer ion conductive film is obtained.

Next, a method of producing a composite ion permeable film having a polymer ion conductive film on at least one surface of an inorganic ion conductor will be described.

The composite ion permeable film having a polymer ion conductive film on at least one surface of an inorganic ion conductor is obtained by, for example, applying the polymer solution obtained by the above-described method to a surface of the inorganic ion conductor and removing a solvent. At this time, a known method can be used as the applying method. Any known method may be used for the method of removing the solvent, and it is preferable to volatilize the solvent at a temperature of 50° C. or higher and 220° C. or lower because the use of water washing or solvent washing may cause elution of lithium element or deactivation of the inorganic ion conductor. More preferably, the temperature is 50° C. to 130° C. under a reduced pressure.

Next, a method of producing an electrode assembly having an electrode for a battery on at least one surface of a polymer ion conductive film or a composite ion permeable film will be described.

The electrode assembly having an electrode for a battery on at least one surface of a polymer ion conductive film is obtained by, for example, applying the above-described polymer solution to the electrode for a battery. Any known method may be used for applying. The electrode assembly having an electrode for a battery on at least one surface of a composite ion permeable film can be obtained by a known method such as pressing a composite ion permeable film and an electrode for a battery in an overlapping manner. In this example, a binder or the like may be appropriately applied onto the composite ion permeable film.

Next, a production method of a secondary battery using a polymer ion conductive film will be described.

The secondary battery using a polymer ion conductive film can be prepared by, for example, using a polymer ion conductive film as a separator and sandwiching the separator between a positive electrode material and a negative electrode material. The positive electrode material is not particularly limited, and examples thereof include inorganic substances such as metal oxides and metal sulfides such as silicon, nickel, lithium, cobalt, and manganese; carbon materials such as graphite, carbon, and CNT; materials in which a metal is supported on the carbon materials; and air electrodes using oxygen in the air as a positive electrode active material. These positive electrodes may be used in combination with a current collector. The negative electrode material is not particularly limited, and examples thereof include simple substances of a metal such as lithium, sodium, aluminum, magnesium, and zinc; and carbon materials and inorganic substances supporting these metals. These negative electrode materials can also be used in combination with a current collector. Any combination of the positive electrode and the negative electrode can be used as necessary. The metal lithium is preferably used for the negative electrode from the viewpoint of increasing the weight energy density. An electrolytic solution may be introduced to ensure the operation stability of the battery. As such an electrolytic solution, a known electrolytic solution can be used.

### Examples

Hereinafter, our membranes, complexes, and batteries will be described in more detail with reference to Examples. Physical properties of the Examples were measured by the following methods.

### (1) Ion Migration Resistance ((2) in Film

A laminate cell was prepared by using a Li metal foil having a shape of 50 mm in height×50 mm in width with protrusions serving as terminals for each of a positive electrode and a negative electrode, with a polymer ion conductive film disposed therebetween. An electrolytic solution inside was 1 M LiTFSI EC/DEC=1/1 (volume ratio). An impedance test was performed from 500 kHz to 10 mHz at an applied voltage of 10 mV using a charge-discharge tester (HJ1005SM8A, manufactured by Hokuto Denko Corporation). Obtained results were represented by a Nyquist plot, and a resistance value of an arc at which an apex of the arc was obtained at a measurement frequency of 1 Hz or less was calculated as an ion migration resistance. When an arc endpoint was not measured up to 10 mHz, a resistance value at 10 mHz was set as the arc endpoint.

(2) Air Permeability (see/100 cc)

Measurement was performed using an Oken-type air permeability meter (EGO-IT, manufactured by Asahi Seiko Co., Ltd.) at an air amount of 100 cc. A measurement upper limit of the device was 10,000 seconds/100 cc. A polymer film was fixed to not cause wrinkles, and the measurement was performed in accordance with JIS P8117:2009. Measurement points were three points at equal intervals in TD, and an average value thereof was used as an air permeability (see/100 cc).

(3) Metal Element Content (μg/g)

An amount of Li element, an amount of Na element, an amount of Mg element, an amount of Zn element, and an amount of Al element contained per 1 g of a polymer were determined using an atomic absorption spectrometer. 0.1 g of a sample (polymer ion conductive film) was weighed out, heated and carbonized by adding sulfuric acid, and then heated and ashed. An ashed product was heated and decomposed with sulfuric acid and hydrofluoric acid, and was heated and dissolved with dilute nitric acid to obtain a constant volume. For this solution, metal elements such as Li element were measured by atomic absorption spectrometry, contents thereof in the sample were determined and converted into a content of lithium Li element, a content of Na element, a content of Mg element, a content of Zn element, and a content of Al element per 1 g of the polymer. When the sample was a laminate, measurement was performed by peeling off only an electrolyte layer.

Device: atomic absorption spectrometer (Z-2300, manufactured by Hitachi High-Tech Science Corporation)

### (4) Film Thickness

A thickness of the polymer ion conductive film was measured using a thickness measuring device (VL-50, manufactured by Mitutoyo Corporation).

### (5) Change in Thickness

A polymer ion conductive film punched into a circle having a diameter of 20 mm was prepared as a sample. Two samples were prepared from the same polymer ion conductive film, and a film thickness of each sample was measured by the above-described thickness measuring device (VL-50, manufactured by Mitutoyo Corporation). One of the samples was subjected to an immersion treatment under condition 1, the other sample was subjected to an immersion treatment under condition 2, and the polymer ion conductive film was pulled up after the immersion treatment. In either immersion treatment, the film was immersed in a solution so that the entire film was immersed. After a surface of the pulled up sample was slightly wiped, the thickness was measured by the thickness measuring device (VL-50, manufactured by Mitutoyo Corporation).
(Condition 1) Immersion in a solution obtained by mixing ethylene carbonate (EC) and diethyl carbonate (DEC) at a volume ratio of 1/1 at 25° C. for 24 hours.
(Condition 2) Immersion in a 0.1 M aqueous solution of sodium hydroxide at 25° C. for 24 hours.

### (6) Number of Pores

Images of arbitrary five places on the surface of the polymer ion conductive film were captured at a magnification of 20,000 times using an SEM (JSM-6700F, manufactured by JEOL Ltd.). The number of pores exceeding 100 nm was counted for each captured image, and a number average value thereof was calculated and converted into the number of pores per 1 μm² to obtain the number of pores (pore/μm²).

### (7) Dendrite Resistance

An HS cell (manufactured by Hohsen Corp.) was used, an NCM positive electrode (manufactured by Hachiyama Corporation), a polymer ion conductive film used for a test, and metal Li were laminated, and 300 μL of 1 M LiTFSI EC/DEC=1/1 (volume ratio) was injected and sealed. Constant current charging up to 4.2 V at 0.05° C. and constant voltage charging at 4.2 V were performed using a charge-discharge tester (HJ1005SM8A, manufactured by Hokuto Denko Corporation), and charging was performed for 48 hours in total. When there was no voltage drop below 4.15 V during charging for 48 h, it was evaluated as “acceptable”.

### (8) Thermal Weight Reduction Rate

Approximately 15 mg of the polymer ion conductive film was weighed and introduced into a thermogravimetric analyzer (TGA). A temperature was increased from room temperature (25° C.) to 200° C. at 10 K/min, and the weight was determined at a time point when the temperature was maintained at 200° C. for 1 hour. Thereafter, a thermal weight reduction rate Wₚ was determined from the formula below. Where W_{f}: amount (mg) of material introduced into TGA, and W₁: weight (mg) of remaining sample after being held at 200° C. for 1 hour.

$${W}_{p} = \frac{{W}_{f} - {W}_{l}}{{W}_{f}} \times 100$$

### (9) Thermal Shrinkage Rate

The polymer film was cut into a size of 50 mm in a longitudinal direction (MD)×50 mm in a width direction (TD), and a length in the longitudinal direction was represented by LMD1 (50 mm) and a length in the width direction was represented by LTD1 (50 mm). Next, the sample was allowed to stand still in a hot air oven at 200° C. for 30 minutes to be subjected to a heat treatment, taken out from the oven, and then cooled. Dimensions of a portion where the length is the shortest in both the longitudinal direction and the width direction of the sample taken out from the oven were measured, the length in the longitudinal direction was represented by LMD2 (mm), and the length in the width direction was represented by LTD2 (mm). The thermal shrinkage rate in each direction was calculated based on formulae (3) and (4), and a value in a direction in which the shrinkage rate was large in MD or TD was defined as a thermal shrinkage rate value. The measurement was performed five times for each sample and averaged.

$$Thermal Shrinkage Rate in MD ( \% ) = [ ( LMD 1 - LMD 2 ) / LMD 1 ] \times 100 \qquad ( 3 )$$

$$Thermal Shrinkage Rate in TD ( \% ) = [ ( LTD 1 - LTD 2 ) / LTD 1 ] \times 100 \qquad ( 4 )$$

In the above evaluation, when the MD direction and the TD direction are unclear, the thermal shrinkage rate at 200° C. is measured for all directions, and a value in a direction in which the thermal shrinkage rate is the largest is defined as the thermal shrinkage rate at 200° C.

### (10) Li Diffusion Distance

The polymer ion conductive film was punched out and laminated on an NMR sample tube for measuring a diffusion coefficient so that a measurement direction of a self-diffusion coefficient and a film thickness direction coincided with each other. Thereafter, the resultant was dried under a reduced pressure at room temperature overnight, added dropwise with an electrolytic solution (1M LiTFSI ethylene carbonate (EC)/diethyl carbonate (DEC)=1/1) in a glove box filled with dry nitrogen to be immersed for 24 hours, and then subjected to 7Li PFG-NMR measurement under the following conditions.

### Conditions

Device: AVANCE III HD400, manufactured by Bruker
Measurement atmosphere: dry nitrogen
Temperature: 25° C.
Observation frequency 7Li: 155.5837090 MHz
Observation width: 10 kHz
Pulse width 90° pulse: 14 μs
Pulse repetition time: ACQTM=102.4 ms
Pulse mode: PGSTE method
Observation time (Δ): 400 milliseconds

The Li diffusion distance was calculated from the obtained self-diffusion coefficient D by the formula below.

$$τ = \frac{{I}_{1} ( V - {R}_{0} {I}_{0} )}{{I}_{0} ( V - {R}_{1} {I}_{1} )}$$

### (11) Lithium Transport Number

An HS cell (manufactured by Hohsen Corp.) was used, metal Li, a polymer ion conductive film used for a test, and metal Li were laminated, and 300 μL of 1 M LiTFSI EC/DEC=1/1 (volume ratio) was injected and sealed. With respect to the prepared cell, the AC impedance was measured at 25° C. under conditions of an amplitude of 10 mV and a frequency of 1 MHz to 100 mHz by an electrochemical testing device (model number: SP-150, manufactured by Biologic), and an interface resistance (R₀) is calculated from the second arc in a Cole plot. Next, an electrode interface DC resistance was measured, a DC voltage (V:) was applied, and an initial current value (I₀) and a current value in a steady state (I₁) were measured. Finally, the AC impedance was measured at 25° C. under conditions of an amplitude of 10 mV and a frequency of 1 MHz to 100 mHz using an electrochemical testing device (model number: SP-150, manufactured by Biologic), and the interface resistance (R₁) was calculated from the second arc in the Cole plot. A lithium transport number (τ) was calculated from the obtained values by the formula below.

$$Lithium diffusion distance = {( 2 \times D \times Δ )}^{0.5}$$

### (12) Ion Conductivity

The polymer film was immersed in a non-aqueous electrolyte (1M LiTFSI ethylene carbonate (EC)/diethyl carbonate (DEC)=1/1) for 24 hours, then placed on a SUS (stainless steel) 304 electrode to cover the electrode portion, and then sandwiched with another SUS electrode after adding the non-aqueous electrolyte dropwise, thereby preparing a laminate of electrode/polymer film/electrode. An evaluation cell was prepared by fixing the laminate with a silicon plate to not be displaced.

With respect to the prepared cell, the AC impedance was measured at 25° C. under conditions of an amplitude of 10 mV and a frequency of 1 MHz to 10 mHz by an electrochemical testing device (model number: SP-150, manufactured by Biologic), and a resistance value was read from a graph plotted on a complex plane and substituted into formula (2) to calculate the ion conductivity. The measurement was performed five times, and the calculated average value was defined as the ion conductivity.
σ=T₀/AR (2)
σ: Ion conductivity (S/cm)
T₀: Thickness (cm) of polymer film
A: Area of electrode (cm²)
R: resistance value (Ω).

### (13) Liquid Separation Test

Two dry 6 mL glass screw bottles (No. 2, manufactured by AS ONE Corporation) were prepared. The electrolytic solution (2.0 mL) was added into one of the bottles, and a film was attached to a mouth of the bottle without a gap. Further, the other bottle was placed on the film so that a mouth of the other bottle faced downward, and was fixed with a tape. The bottle containing the electrolytic solution was left to stand to be upper side, presence or absence of outflow of the solution into the lower bottle was confirmed, and the time until the outflow was measured. A test was performed for each of when an aqueous electrolytic solution was used and when an organic electrolytic solution was used, as the aqueous electrolytic solution, a 0.1 M aqueous solution of LiOH was used, and as the organic electrolytic solution, 1 M LiTFSI EC/DEC=1/1 was used. Reference Example 1 Polymer Solution P-1

In dehydrated NMP (N-methyl-2-pyrrolidone, manufactured by Mitsubishi Chemical Corporation), 4,4′-diaminodiphenyl ether (manufactured by Tokyo Chemical Industry Co., Ltd.) was dissolved as a diamine under a nitrogen gas stream, and cooled to 30° C. or lower. In a state in which the inside of the system was kept at 30° C. or lower under a nitrogen gas stream, 2-chloroterephthaloyl chloride (manufactured by Nippon Light Metal Co., Ltd.) corresponding to 99 mol % with respect to a total amount of the diamine was added thereto over 30 minutes, and after addition of the total amount, the aromatic polyamide was polymerized by stirring for about 2 hours. The obtained polymerization solution was neutralized with 97 mol % lithium carbonate (manufactured by Honjo Chemical Corporation) and 6 mol % diethanolamine (manufactured by Tokyo Chemical Industry Co., Ltd.) with respect to the total amount of acid chloride to obtain a polymer solution P-1.

A viscosity η of the obtained polymer was 2.5 dL/g.

### Reference Example 2 Polymer Solution P-2

The polymer solution P-1 was added to purified water of 10 times or more in terms of weight ratio, and a solvent and a neutralized salt were extracted into water to separate only a precipitated polymer, followed by vacuum drying at 80° C. for 10 hours to obtain a polymer powder. Thereafter, the polymer powder was redissolved in dehydrated NMP (manufactured by Mitsubishi Chemical Corporation) so that a polymer concentration was 8 mass %, thereby obtaining a polymer solution P-2.

### Reference Example 3 Polymer Solution P-3

LiTFSI in a weight of 0.47 times an amount of the polymer dissolved in the polymer solution P-2 was added and completely dissolved to obtain a polymer solution P-3.

### Reference Example 4 Polymer Solution P-4

LiTFSI in a weight of 1.18 times an amount of the polymer dissolved in the polymer solution P-2 was added and completely dissolved to obtain a polymer solution P-4.

### Reference Example 5 Polymer Solution P-5

A polymer solution P-5 was obtained by performing polymerization in the same manner as in Reference Example 1 except that the diamine used was changed to 1,4-bis(4-aminophenoxy)benzene. A viscosity η of the obtained polymer was 2.1 dL/g.

### Reference Example 6 Polymer Solution P-6

The polymer solution P-5 was added to purified water of 10 times or more in terms of weight ratio, and a solvent and a neutralized salt were extracted into water to separate only a precipitated polymer, followed by vacuum drying at 80° C. for 10 hours to obtain a polymer powder. Thereafter, the polymer powder was redissolved in dehydrated NMP (manufactured by Mitsubishi Chemical Corporation) so that a polymer concentration was 8 mass %, thereby obtaining a polymer solution P-6.

### Reference Example 7 Polymer Solution P-7

LiTFSI in a weight of 0.25 times an amount of the polymer dissolved in the polymer solution P-6 was added and completely dissolved to obtain a polymer solution P-7.

### Reference Example 8 Polymer Solution P-8

LiTFSI in a weight of 0.50 times an amount of the polymer dissolved in the polymer solution P-6 was added and completely dissolved to obtain a polymer solution P-8.

### Reference Example 9 Polymer Solution P-9

A polymer solution was adjusted in the same manner as in Reference Example 3 except that LiFSI was used instead of LiTFSI to obtain a polymer solution P-9.

### Reference Example 10 Polymer Solution P-10

A polymer solution was adjusted in the same manner as in Reference Example 3 except that a polymer concentration was 6 mass % to obtain a polymer solution P-10.

### Example 1

The polymer solution P-3 prepared in Reference Example 3 was applied in a film shape onto a glass plate as a support and dried in a hot air oven at 130° C. until the film had self-supporting properties, and then the film was peeled off from the support. Next, the peeled film was fixed to a metal frame, and dried in a vacuum dryer at 130° C. for 1 hour. Characteristics of the obtained polymer ion conductive film are shown in Table 1.

### Example 2

A film was formed in the same manner as in Example 1 except that the polymer solution P-4 prepared in Reference Example 4 was used. Characteristics of the obtained polymer ion conductive film are shown in Table 1.

### Example 3

A film was formed in the same manner as in Example 1 except that the polymer solution P-7 prepared in Reference Example 7 was used. Characteristics of the obtained polymer ion conductive film are shown in Table 1.

### Example 4

A film was formed in the same manner as in Example 1 except that the polymer solution P-8 prepared in Reference Example 8 was used.

Characteristics of the obtained polymer ion conductive film are shown in Table 1.

### Example 5

A film was formed in the same manner as in Example 1 except that the polymer solution P-9 prepared in Reference Example 9 was used.

Characteristics of the obtained polymer ion conductive film are shown in Table 1.

### Example 6

A polymer solution P-10 was coated onto one surface of a polypropylene porous film substrate (thickness of 25 μm, air permeability of 191 sec/100 cc) as a coating liquid by gravure coating. After the coating, the porous film substrate was dried at 100° C. for 15 minutes and then vacuum-dried at 100° C. for 60 minutes to form a polymer film on the porous film substrate, thereby obtaining a film.

### Comparative Example 1

A film was formed in the same manner as in Example 1 except that the polymer solution P-2 prepared in Reference Example 2 was used. Characteristics of the obtained polymer ion conductive film are shown in Table 1. The film obtained in Comparative Example 1 has low ion conductivity, and the lithium transport number and the dendrite resistance cannot be evaluated. In addition, the Li diffusion coefficient cannot be calculated.

### Comparative Example 2

The polymer solution P-3 prepared in Reference Example 3 was applied in a film shape onto a glass plate as a support, followed by drying in a hot air oven at 130° C. until the film had self-supporting properties, and thereafter, the film was fixed to a metal frame and introduced into a water bath at 60° C. to extract a solvent. Thereafter, moisture was dried in an oven at 130° C. Characteristics of the obtained polymer ion conductive film are shown in Table 1. The film obtained in Comparative Example 2 has low ion conductivity, and the lithium transport number and the dendrite resistance cannot be evaluated. In addition, the Li diffusion coefficient cannot be calculated.

### Comparative Example 3

An acetonitrile solution to which 10 mass % of polyethylene oxide (weight average molecular weight: 900,000) and LiTFSI in a weight of 0.47 times an amount of a polymer were added was applied in a film shape on a Teflon (registered trademark) sheet, followed by drying in a hot air oven at 40° C. until the film had self-supporting properties and further drying in a vacuum dryer at 40° C. for 3 hours, and thereafter, the film is peeled from a support to obtain a polymer ion conductive film. However, when being immersed at 25° C. for 24 hours in a solution in which ethylene carbonate (EC) and diethyl carbonate (DEC) were mixed at a volume ratio of 1/1 and a 0.1 M aqueous solution of sodium oxide, the obtained polymer ion conductive film did not have self-supporting properties due to swelling and dissolution. In the liquid separability test of the organic electrolytic solution and the aqueous electrolytic solution, the time until outflow was within 3 hours.

According to Table 1, compared to Comparative Examples 1 and 2, Examples 1 to 6 have small ion migration resistance in the film and high ion conductivity, and function as a polymer ion conductive film. At the same time, in addition to the dendrite resistance, the liquid separability evaluated in the liquid separation test is excellent. Further, polyethylene oxide, which is a typical polymer ion conductive film used in Comparative Example 3, does not have liquid separability.

TABLE 1

| | | | | | | | | Comp. | Comp. |
|---|---|---|---|---|---|---|---|---|---|
| | | Ex. 1 | Ex. 2 | Ex. 3 | Ex. 4 | Ex. 5 | Ex. 6 | Ex. 1 | Ex. 2 |
| Polymer solution | | P-3 | P-4 | P-7 | P-8 | P-9 | P-10 | P-2 | P-3 |
| Ion migration resistance | | 8 | 5 | 9 | 4 | 7 | 5 | 3,200 | 1,800 |
| (Ω) in film @25° C. | | | | | | | | | |
| Content (μg/g) of Li element | | 7,200 | 19,100 | 3,200 | 7,500 | 10,800 | 1,580 | 28 | 38 |
| Thermal weight reduction rate (%) | | 3 | 5 | 2 | 3 | 3 | 1 | 2 | 3 |
| Film thickness (μm) | | 5 | 7 | 3 | 4 | 5 | 25 | 7 | 10 |
| Change | EC/DEC | 1.2 | 1.3 | 1.1 | 1.3 | 1.1 | 1.0 | 1.2 | 1.1 |
| (times) in | (condition 1) | | | | | | | | |
| film | Aqueous solution of | 1.0 | 1.0 | 1.0 | 1.0 | 1.0 | 1.0 | 1.0 | 1.0 |
| thickness | sodium hydroxide | | | | | | | | |
| | (condition 2) | | | | | | | | |
| Li diffusion distance (μm) | | 4.1 | 4.8 | 3.8 | 5.5 | 3.5 | 4.5 | — | — |
| Lithium transport number | | 0.6 | 0.6 | 0.5 | 0.5 | 0.6 | 0.6 | — | — |
| Total atom number density of | | 15 | 15 | 14 | 14 | 15 | 15 | 15 | 14 |
| F, O, N, Cl, S atoms (%) | | | | | | | | | |
| Thermal shrinkage rate at 200° C. (%) | | 8 | 11 or more | 7 | 9 | 7 | molten | 1 or less | 1 or less |
| Number of pores (pore/μm²) | | 0 | 0 | 0 | 0 | 0 | 0 | 0 | 2.2 |
| Ion conductivity (×10⁻⁵ S/cm) | | 2.1 | 3.0 | 1.8 | 13 | 2.3 | 3.2 | 0.01 or | 0.01 or |
| | | | | | | | | less | less |
| Dendrite resistance | | Acceptable | Acceptable | Acceptable | Acceptable | Acceptable | Acceptable | — | — |
| Liquid | Organic electrolyte | 24 hours | 24 hours | 24 hours | 24 hours | 24 hours | 24 hours | 24 hours | 24 hours |
| separation | solution | or longer | or longer | or longer | or longer | or longer | or longer | or longer | or longer |
| test | Aqueous electrolyte | 24 hours | Five hours | 24 hours | Three | 24 hours | 24 hours | 24 hours | 24 hours |
| | solution | or longer | | or longer | hours | or longer | or longer | or longer | or longer |

Although our membranes, complexes, and batteries have been described in detail with reference to specific examples, it is apparent to those skilled in the art that various changes and modifications can be made without departing from the spirit and the scope of this disclosure and the appended claims.

1. A polymer ion conductive film comprising:
an ion migration resistance in the film at 25° C. is 100 (2 or less, and a thickness of the film after each of immersion treatments under conditions 1 and 2 is 2.5 times or less a thickness of the film before the immersion treatment:
(condition 1) immersion at 25° C. for 24 hours in a solution obtained by mixing ethylene carbonate (EC) and diethyl carbonate (DEC) at a volume ratio of 1/1;
(condition 2) immersion at 25° C. for 24 hours in a 0.1 M aqueous solution of sodium hydroxide.

2. The polymer ion conductive film according to claim 1, wherein the number of pores having a diameter exceeding 100 nm on at least a surface on one side of the polymer ion conductive film is 5 pores/μm² or less.

3. The polymer ion conductive film according to claim 1, wherein an air permeability is 1000 sec/100 cc or more.

4. The polymer ion conductive film according to claim 1, wherein the thickness of the film after each of the immersion treatments under the conditions 1 and 2 is 1.5 times or less the thickness of the film before the immersion treatment.

5. The polymer ion conductive film according to claim 1, wherein the thickness of the film after each of the immersion treatments under the conditions 1 and 2 is 1.0 time or more and 1.5 times or less the thickness of the film before the immersion treatment.

6. The polymer ion conductive film according to claim 1, wherein a weight reduction rate when heated from 25° C. to 200° C. is 20% or less.

7. The polymer ion conductive film according to claim 1, wherein a content of one or more metal elements selected from the group consisting of lithium, sodium, magnesium, zinc, and aluminum per 1 g of a polymer constituting the polymer ion conductive film is 50 μg or more and 300,000 μg or less.

8. The polymer ion conductive film according to claim 1, wherein a Li diffusion distance determined by measurement by a pulsed field gradient nuclear magnetic resonance (PFG-NMR) method is 0.0002 μm or more and 5.5 μm or less.

9. The polymer ion conductive film according to claim 1, wherein a content of a lithium element per 1 g of a polymer constituting the polymer ion conductive film is 50 μg or more and 300,000 μg or less.

10. The polymer ion conductive film according to claim 1, wherein a lithium transport number is 0.5 or more and 1.0 or less.

11. The polymer ion conductive film according to claim 1, comprising a polymer having a total atom number density of F atom, O atom, N atom, Cl atom, and S atom of 9% or more and 100% or less.

12. The polymer ion conductive film according to claim 1, wherein a thermal shrinkage rate at 200° C. is 0% or more and 10% or less.

13. The polymer ion conductive film according to claim 1, comprising one or more selected from the group consisting of polyphenylene sulfide, polyamide, polyarylene ether, polyethersulfone, polyimide, polyamide-imide, polyarylene ether ketone, and copolymers thereof.

14. A polymer ion conductive film for a secondary battery, which is the polymer ion conductive film according to claim 1.

15. A composite ion permeable film comprising the polymer ion conductive film according to claim 1 on at least one surface of an inorganic ion conductor.

16. An electrode assembly comprising an electrode for a battery on at least one surface of the polymer ion conductive film according to claim 1.

17. An electrode assembly comprising an electrode for a battery on at least one surface of the composite ion permeable film according to claim 15.

18. A secondary battery comprising the electrode assembly according to claim 16.

19-21. (canceled)

22. A polymer ion conductive film, wherein a content of one or more metal elements selected from the group consisting of lithium, sodium, magnesium, zinc, and aluminum per 1 g of a polymer constituting the polymer ion conductive film is 50 μg or more and 300,000 μg or less, and the polymer ion conductive film comprises one or more selected from the group consisting of polyphenylene sulfide, polyamide, polyarylene ether, polyethersulfone, polyimide, polyamide-imide, polyarylene ether ketone, and copolymers thereof.
